(19) United States
(12) Patent Application Publication
(10) Pub. No.: US 2006/0132958 A1
(43) Pub. Date: Jun. 22, 2006

(54) Fault diagnosis apparatus, recording medium recording fault diagnosis program and fault diagnosis method

(75) Inventors: Sinji Kouno, Saitama-shi (JP); Shohei Ikenoue, Saitama-shi (JP); Kentaro Fukami, Saitama-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/136,426

(22) Filed: May 25, 2005

(30) Foreign Application Priority Data
Dec. 17, 2004 (JP) 2004-365361

(51) Int. Cl. G11B 19/02

(52) U.S. Cl. 360/69

(57) ABSTRACT

A fault diagnosis apparatus are installed and used in information equipment. The information equipment has a disk drive and a vibration source that causes vibrations or being subject to vibrations from an external vibration source. The apparatus has a measuring unit and a diagnosis unit. The measuring unit performs a measurement for a functional operation in the disk drive under a condition that the vibrations are occurred. The diagnosis unit performs a fault diagnosis based on a measurement result by the measuring unit.

### BACKGROUND OF THE INVENTION

1. Field of the Invention

The present invention relates to a fault diagnosis apparatus, recording medium recording a fault diagnosis program and fault diagnosis method for using in information equipment having a disk drive for storing information.

2. Description of the Related Art

In recent years, information equipment having a disk drive typically such as a Hard Disk Drive (HDD) is well known. In the information equipment, a fault or problem, for example, occurring in the disk drive has an influence on a function of the information equipment. Accordingly, performing a fault diagnosis on a disk drive included in information equipment has been proposed (see JP-A-2001-101852 and JP-A-2001-307435, for example) by monitoring the operation state and/or performing an error check by using an input signal from a recording head.

Notably, some information equipment having a disk drive, such as a copier, a printer and a multifunction machine having these functions, may have a drive mechanism such as a scanner and printer engines. In the information equipment, when the motor or clutch in the drive mechanism operates, the drive mechanism may possibly be a vibration source that causes vibrations. In the information equipment having the vibration source, data may need to be read or written from/to the disk drive under a circumstance that the vibration source is causing vibrations. The same is completely true not only for the information equipment including the drive mechanism possibly being the vibration source but also for information equipment for use in an environment subject to vibrations from an external vibration source, such as a car navigation system.

On the other hand, the magnitude of vibrations caused by the vibration source may be increased with time due to deterioration of a vibration isolator supporting the vibration source for example, causing an adverse influence on the disk drive beyond the originally expected magnitude. Thus, the vibrations may prevent the disk drive from functioning normally when data is read/written under the circumstance that a vibration source is causing vibrations. More specifically, a large difference in vibration states occurs between the operating state and nonoperating state of the drive mechanism. That is, the performance required by the disk drive may be satisfied at the nonoperating state while the required performance may not be satisfied at the operating state.

On the other hand, since the conventional technology does not expect that the disk drive is subject to an influence of vibrations, the trouble only occurring under a condition that vibrations are being caused cannot be detected even when a fault diagnosis is performed. Furthermore, since the conventional technology requires a special function for attenuating an input signal from a recording head, the conventional technology is not always easily applicable to all disk drive.

### SUMMARY OF THE INVENTION

Accordingly, the present invention has been made in view of the above circumstances and provides a fault diagnosis apparatus, recording medium recording a fault diagnosis program and fault diagnosis method, which allow an accurate fault diagnosis on a disk drive even when vibrations caused by a vibration source have an influence in information equipment having the disk drive and allow an easy fault diagnosis without requiring any special function therefor.

According to an aspect of the invention, a fault diagnosis apparatus for use in information equipment having a disk drive that stores information and having a vibration source that causes vibrations or being subject to vibrations by an external vibration source includes a measuring unit that performs a measurement for a functional operation in the disk drive under a condition that the vibrations are occurred by the vibration source, and a diagnosis unit that performs a fault diagnosis based on a measurement result by the measuring unit.

### BRIEF DESCRIPTION OF THE DRAWINGS

Embodiments of the present invention will be described in detail based on the following figures, wherein:

FIG. 1 is a functional block diagram showing a schematic configuration example of a fault diagnosis apparatus according to a first embodiment of the invention and a multifunction machine applying the fault diagnosis apparatus;

FIG. 2 is an explanatory diagram showing an outline of a measuring unit according to the first embodiment of the invention;

FIGS. 3A to 3D are flowcharts (Number 1) showing a specific example of steps of a fault diagnosis method according to an embodiment of the invention;

FIG. 4 is a flowchart (Number 2) showing a specific example of steps of a fault diagnosis method according to an embodiment of the invention;

FIG. 5 is an explanatory diagram showing an outline of a measuring unit according to a second embodiment of the invention;

FIG. 6 is a functional block diagram showing a schematic configuration example of a fault diagnosis apparatus according to a third embodiment of the invention and a multifunction machine applying the fault diagnosis apparatus;

FIG. 7 is an explanatory diagram showing an outline of a storage area for history management according to the third embodiment of the invention;

FIG. 8 is a functional block diagram showing a schematic configuration example of a fault diagnosis apparatus according to a fourth embodiment of the invention and a multifunction machine applying the fault diagnosis apparatus; and

FIG. 9 is a flowchart showing a processing operation example according to the fourth embodiment of the invention.

### DETAILED DESCRIPTION OF THE INVENTION

A fault diagnosis apparatus, recording medium recording a fault diagnosis program and fault diagnosis method according to an embodiment of the present invention will be described below with reference to drawings. Here, a multifunction machine is an example of information equipment having a disk drive, and a case will be described in which multiple drive mechanisms such as a scanner and printer engines in the multifunction machine can be a vibration source.

### First Embodiment

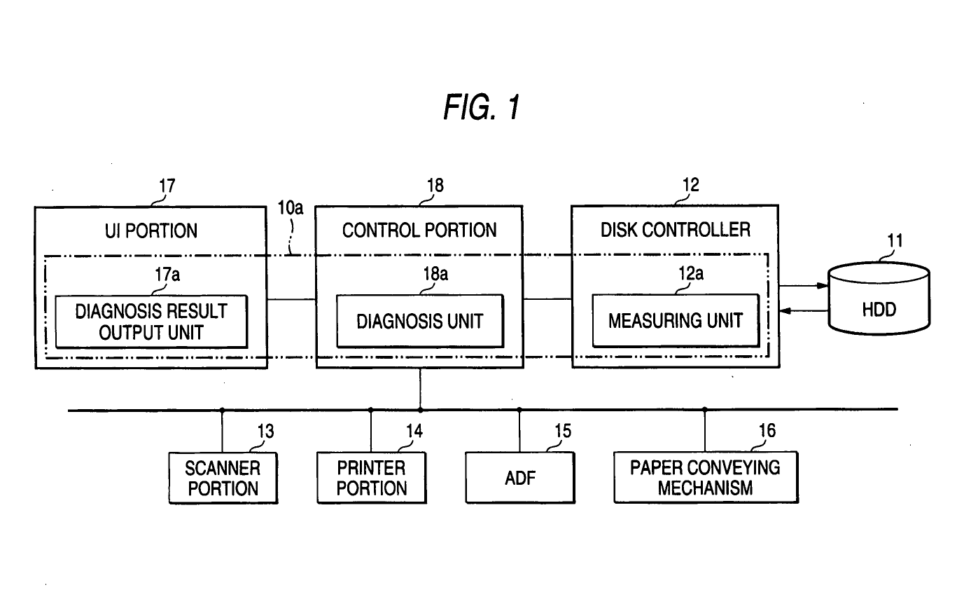

FIG. 1 is a functional block diagram showing a schematic configuration example of a fault diagnosis apparatus according to a first embodiment of the invention and a multifunction machine applying the fault diagnosis apparatus.

First of all, a schematic configuration of a multifunction machine 10 will be described. The shown multifunction machine 10 includes an HDD 11, a disk controller 12, a scanner portion 13, a printer engine 14, an ADF 15, a paper conveying mechanism 16, a user interface (UI) portion 17 and a control portion 18.

According to an aspect of the invention, the HDD 11 stores information such as spooling image data and the HDD 11 functions as a disk drive. However, the disk drive only needs to store information and is not always limited to an HDD having a magnetic disk and may apply an optical disk or optical magnetic disk, for example.

The disk controller 12 controls an operation of the HDD 11 and also controls writing information to the HDD 11 and reading information from the HDD 11. The disk controller 12 functionally includes a measuring unit 12a, which will be described later in detail.

The scanner portion 13 scans image data from an original. The printer engine 14 prints image data on paper to record. The ADF 15 automatically feeds an original to be scanned by the scanner portion 13. The paper conveying mechanism 16 supplies paper to record to the printer engine 14 or inverts paper for double-sided output. In other words, these components 13 to 16 function as the multifunction machine 10. However, the components 13 to 16 have a motor, a clutch and so on and may cause vibrations from the operation. That is, the components 13 to 16 may become a vibration source causing vibrations. Notably, the components 13 to 16 are only examples as vibration sources, and the vibration source here is not limited thereto.

According to an aspect of the present invention, the UI portion 17 is manipulated by a user of the multifunction machine 10 and functions as an operating portion. More specifically, the UI portion 17 is used for outputting and displaying various information to a user or receiving information inputted by a user. The UI portion 17 functionally includes a diagnosis result output unit 17a, which will be described later in detail.

The control portion 18 includes a CPU for executing a predetermined program and controls operations on the components 11 to 17. The control portion 18 functionally includes a diagnosis unit 18a, which will be described later in detail.

Next, the fault diagnosis device 10a installed and used in the multifunction machine 10 will be described. The fault diagnosis device 10a includes the measuring unit 12a, the diagnosis unit 18a and the diagnosis result output unit 17a.

The measuring unit 12a performs a measurement for a functional operation in the HDD 11. The expression, “measurement for a functional operation”, refers to a measurement to be performed for detecting an operation state of the HDD 11 and supplying the result to the fault diagnosis and a measurement which can be performed in accordance with an operation command to the HDD 11 without requiring any special function such as signal processing.

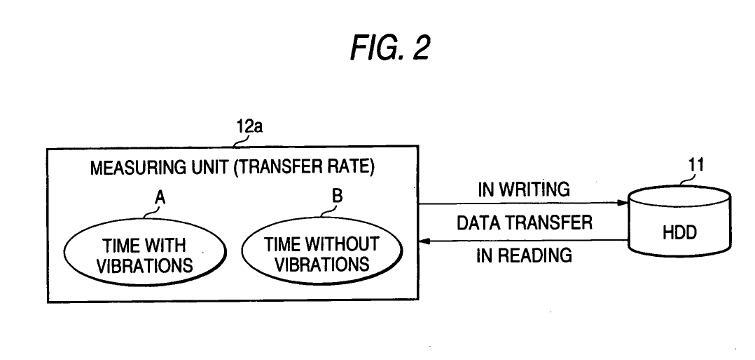

FIG. 2 is an explanatory diagram showing an outline of the measuring unit according to the first embodiment of the invention. As shown in FIG. 2, the measuring unit 12a measures a transfer rate during information transfer in the HDD 11 as the measurement for a functional operation in the HDD 11. The measuring unit 12a individually can measure both of the transfer rate for writing information to the HDD 11 and the transfer rate for reading information from the HDD 11 independently. However, the measuring unit 12a may only measure either one of them.

A publicly known technology may be used for measuring transfer rates for both writing and reading information. For example, when data is transferred between the disk controller 12 and the HDD 11, the transfer rate can be measured by measuring a time from the start of the data transfer to the end of the transfer and dividing the amount of data to transfer by the measured transfer time.

Furthermore, the measuring unit 12a measures the transfer rate at least when a vibration source in the multifunction machine 10 causes vibrations. More specifically, the measuring unit 12a measures the transfer rates for the time A with vibrations by a vibration source and the time B without vibrations. However, though measuring the transfer rates at both times may be performed, the expression, “at least”, refers to that measuring both of them is not always required and measuring a transfer rate at the time A with vibrations is only required.

The diagnosis unit 18a shown in FIG. 1 performs fault diagnosis based on a measurement result from the measuring unit 12a. For example, the fault diagnosis may be performed by comparing the measuring result by the measuring unit 12a with a predetermined reference value or with a measuring result obtained in the past or by comparing the measuring results at the time A with vibrations and the time B without vibrations with each other. The term, “fault”, here refers to a fault in a vibration source in the multifunction machine 10 (such as an increase in vibrations) in addition to an operational fault (including a decrease in function in addition to functional shut-down) in the HDD 11.

The diagnosis result output unit 17a outputs and displays a result of a fault diagnosis by the diagnosis unit 18a to a user of the multifunction machine 10.

The units 12a, 17a and 18a may be hardware circuits such as a specific Application Specified Integrated Circuit (ASIC) or may be software functionally operating as a computer in the multifunction machine 10, for example. In this case, the software configuration may be stored and provided in a computer-readable recording medium or may be delivered through a wired or wireless communication unit instead of being installed in the multifunction machine 10. In other words, the fault diagnosis apparatus 10a in this embodiment can be implemented by a fault diagnosis program causing the multifunction machine 10 to function as the fault diagnosis apparatus 10a.

Next, a processing operation example in the fault diagnosis apparatus (including the one implemented by the fault diagnosis program) 10a with the construction, that is, a fault diagnosis method according to the first embodiment of the invention will be described.

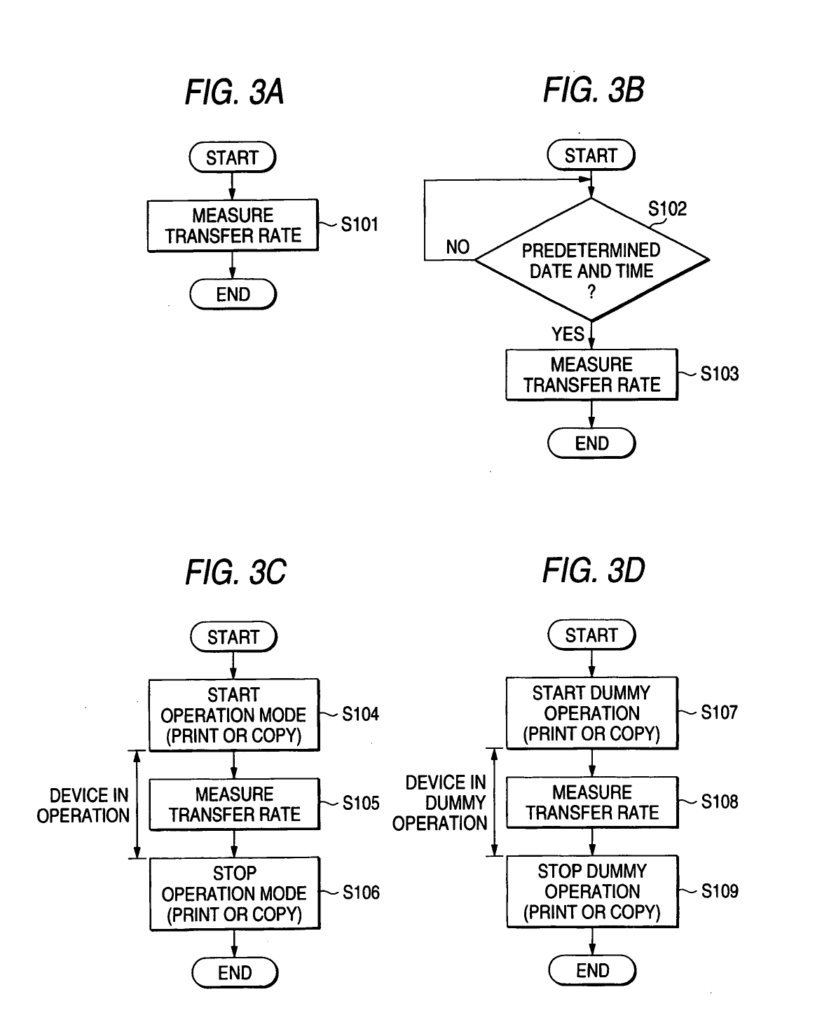

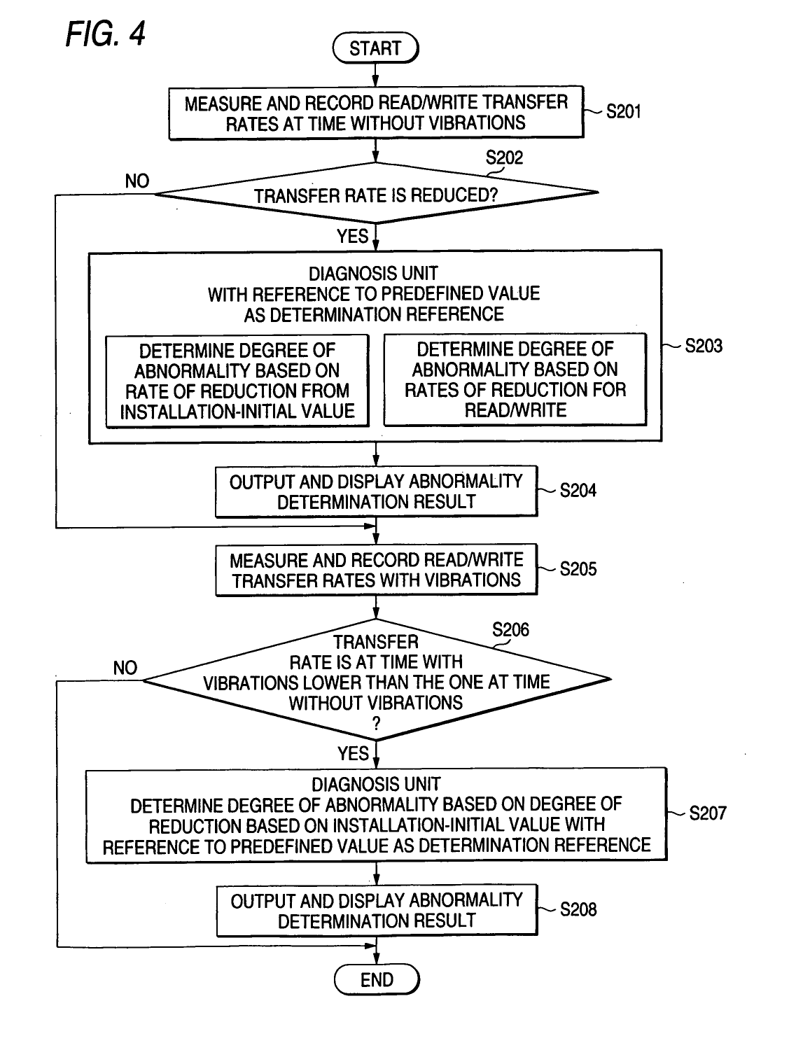

FIGS. 3A to 3D and FIG. 4 are flowcharts illustrating specific examples of steps of the fault diagnosis method according to this embodiment of the invention.

In the fault diagnosis apparatus 10a, as shown in FIG. 3A, powering on the multifunction machine 10 triggers the measuring unit 12a to start measuring a transfer rate in the HDD 11 (step 101, the term, step, being abbreviated as “S”, hereinafter). Alternatively, as shown in FIG. 3B, after powering on the multifunction machine 10, the measuring unit 12a may measure transfer rates in the HDD 11 (S103) periodically at predetermined dates and times (S102) while the multifunction machine 10 is operating. Alternatively, as shown in FIG. 3C, a manipulation on the UI portion 17 to output an operational command to one of the components 13 to 16 may trigger the measuring unit 12a to start measuring a transfer rate in the HDD 11 (S104 to S106). In this case, multiple operation modes are available which are commanded by a manipulation on the UI portion 17, and the vibration source causing vibrations depends on the commanded operation mode (such as copy/print, double/single sided copy and print, ADF/platen copy, tray/stack output and compliant paper size). Therefore, measuring a transfer rate may be started in accordance with every operation command whenever the UI portion 17 is manipulated or may be performed only in a predetermined specific operation mode. One of the measurement timings may be only adopted, or the multiple measurement timings may be adopted in combination.

Notably, the measuring unit 12a measures transfer rates at both of the time A with vibrations from a vibration source and the time B without vibrations. Note that both of the measurements at the time A with vibrations and at the time B without vibrations may be performed in one of the measurement timings, or each of the measurements may be performed in a different timing such as at the time A with vibrations in one timing and at the time B without vibrations in another timing. The same is completely true at the time of writing information and at the time of reading information.

At the time A with vibrations, as shown in FIG. 3C, after one of the components 13 to 16 operates and starts causing vibrations (S104), transfer-rate measurement is performed until the operation stops. As described above, the operation mode that the measurement corresponds to may be predetermined.

The expression, “operation mode”, here includes not only the one to be performed in response to a manipulation on the UI portion 17 but also the one independent of a manipulation on the UI portion 17 such as a copy output mode and a print output mode. The operation mode independent of a manipulation on the UI portion 17 includes an initializing operation after powering on the multifunction machine 10 or before starting the copy output mode or print output mode, for example. In other words, the operation mode includes a dummy operation. As shown in FIG. 3D, even at the time A with vibrations due to the dummy operation, after the dummy operation starts and one of the components 13 to 16 starts causing vibrations (S107), transfer-rate measurement may be performed (S108) until the operation stops (S109).

Since the method for measuring a transfer rate by the measuring unit 12a may be performed by use of a well-known technology, the detail description will be omitted herein. The result of the measurement of a transfer rate by the measuring unit 12a is stored and held in a specific storage area. The specific storage area only needs to be accessible by the control portion 18 and may be in the HDD 11 or in another memory, not shown.

After the measuring unit 12a performs the transfer-rate measurement, the diagnosis unit 18a performs a fault diagnosis based on the measurement result.

More specifically, as shown in FIG. 4, in a measurement timing (for example, after powering on the multifunction machine 10), the measuring unit 12a measures transfer rates for writing information and reading information at the time B without vibrations and stores and holds the measurement results in a specific storage area (S201). Then, the diagnosis unit 18a determines whether the transfer rate is reduced or not based on the measurement result (S202). The determination may be performed by comparing the measurement result by the measuring unit 12a with a predetermined reference value or with a measurement result measured by the measuring unit 12a before the measurement result is obtained and stored and held in a specific storage area.

If the transfer rate is reduced as a result of the determination, the diagnosis unit 18a obtains the rate of reduction and determines the degree of the abnormality (S203). For example, the diagnosis unit 18a compares the measurement result of the transfer rate obtained in a measurement timing with the measurement result obtained at the initial stage of the operation of the multifunction machine 10 (that is, when the operation is started after shipping to a factory) among measurement results stored and held in a specific storage area, that is, with the result of the transfer-rate measurement when the multifunction machine 10 is not in use (or at a state close to not being in use) and obtains the rate of reduction. Then, the diagnosis unit 18a compares the rate of reduction with a predetermined determination reference and determines the degree of the abnormality due to the reduction in transfer rate (that is, either a degree requiring alarming or a degree just requiring calling attention, for example). In accordance or independently, the diagnosis unit 18a compares the measurement result at the time of writing information and measurement result at the time of reading information obtained in an equal timing and obtains the rate of reduction. Then, the diagnosis unit 18a compares the rate of reduction with a predetermined determination reference and determines the degree of the abnormality due to the reduction in a transfer rate (that is, either a degree requiring alarming or a degree just requiring calling attention, for example).

The determination result by the diagnosis unit 18a is output and displayed by the diagnosis result output unit 17a to a user of the multifunction machine 10 as required (S204).

After the determination for the time B without vibrations is performed, the diagnosis unit 18a subsequently performs the determination for the time A with vibrations. In other words, in a measurement timing (which may be an equal timing to that of the time B without vibrations or may be a different timing), the measuring unit 12a measures transfer rates at the time of writing information and reading information for the time A with vibrations and stores and holds the measurement results in a specific storage area (S205). Then, the diagnosis unit 18a determines whether the transfer rate is reduced or not based on the measurement results (S206). The determination is performed by comparing the measurement result by the measuring unit 12a with the previously obtained measurement result for the time B without vibrations. Note that, like the case for the time B without vibrations, the determination may be performed by comparing the measurement results by the measuring unit 12a with a predetermined reference value or with the measurement result measured by the measuring unit 12a before the measurement result is obtained and stored and held in a specific storage area.

If the transfer rate is reduced as a result of the determination, the diagnosis unit 18a further obtains the rate of reduction and determines the degree of abnormality (S207). Here, the determination of the degree of abnormality may be performed in the same manner as that for the time B without vibrations. Note that, the degree of abnormality is determined by comparing the measurement result obtained by the measuring unit 12a for the time A with vibrations with a predetermined determination reference or the measurement result obtained by the measuring unit 12a for the time B without vibrations.

The determination result by the diagnosis unit 18a is also output and displayed by the diagnosis result output unit 17a to a user of the multifunction machine 10 as required (S208).

Through these steps, a fault in the HDD 11 or a problem in the multifunction machine 10 including the HDD 11 can be determined by determining the rate of reduction in transfer rate of the HDD 11 in the fault diagnosis apparatus (including the fault diagnosis program) 10a and fault diagnosis method according to this embodiment.

More specifically, (1): since a problem in the HDD 11 only occurring at the time A with vibrations is detected, the problem can be determined as abnormal based on an amount of data to be transferred even when the problem is less frequent and even when the occurrence of a problem depends on the difference of potation modes, that is, even when a problem occurs at one operation mode but does not occur at another operation mode.

Furthermore, (2): since the determination is performed for both of the time A with vibrations and the time B without vibrations, it can be determined that the HDD 11 itself has a problem when the transfer rate is reduced independent of the presence of vibrations. On the other hand, (3): It can be determined that a serious problem is occurring in the attachment of the HDD 11 or one of the components 13 to 16 possibly being the vibration source rather than the HDD 11 when the transfer rate is reduced only at the time A with vibrations. Furthermore, (4): when the transfer rate is reduced at the time A with vibrations and only during the time for information writing, it can be determined that a small problem is occurring in the attachment of the HDD 11 or one of the components 13 to 16 possibly being the vibration source. The HDD 11 controls the movement of the recording head during the time for information writing more strictly than that during the time for information reading and requires time for stabilizing the position of the recording head even with small vibrations. In other words, the HDD 11 operates during the time for information writing under more strict condition. Therefore, a small problem if any may appear as a reduction in transfer rate during the time for information writing though the problem does not occur during the time for information reading.

This determination allows the isolation between the case with a problem in the HDD 11 and the case with a problem in the multifunction machine 10 including the HDD 11, and unnecessary parts exchanges and/or reoccurrence of a problem can be avoided when the problem is addressed.

As described above, in the fault diagnosis apparatus (including the fault diagnosis program) 10a and fault diagnosis method according to this embodiment, the measurement is performed for a functional operation in the HDD 11 when a vibration source is causing vibrations. Thus, a fault diagnosis for the HDD 11 can be performed accurately in the multifunction machine 10 having the HDD 11 even with an influence of vibrations caused by one of the components 13 to 16 possibly being a vibration source. Furthermore, since the fault diagnosis is performed based on the measurement result for the functional operation in the HDD 11, a measurement result in accordance with an operation command to the HDD 11 can be obtained, and no special function such as signal processing is required therefor.

In particular, as in this embodiment, fault diagnoses in various patterns can be implemented as in (1) to (4) above by measuring functional operations for both of the time with vibrations and time without vibrations and performing a fault diagnosis based on the both measurement results, which allows highly accurate fault diagnosis.

In particular, the measurement for a functional operation is implemented by measuring a transfer rate during information transfer in the HDD 11 in this embodiment, which allows greatly easy fault diagnosis thereof.

Since the measuring unit 12a measures transfer rates in various timings and operation modes in addition to the times for information writing and information reading to/from the HDD 11 in this embodiment, problems can be distinguished accurately as described above for avoiding unnecessary parts exchanges and reoccurrence of problems, for example.

Since the diagnosis result output unit 17a outputs and displays a result of the fault diagnosis by the diagnosis unit 18a in this embodiment, a user of the multifunction machine 10 can easily recognize and grasp the diagnosis result, which is highly convenient to users.

### Second Embodiment

Next, a second embodiment of the invention will be described. Only differences between the first embodiment and the second embodiment will be described herein, and the description of the rest will be omitted.

The fault diagnosis apparatus according to this embodiment has a different measuring unit from that of the first embodiment.

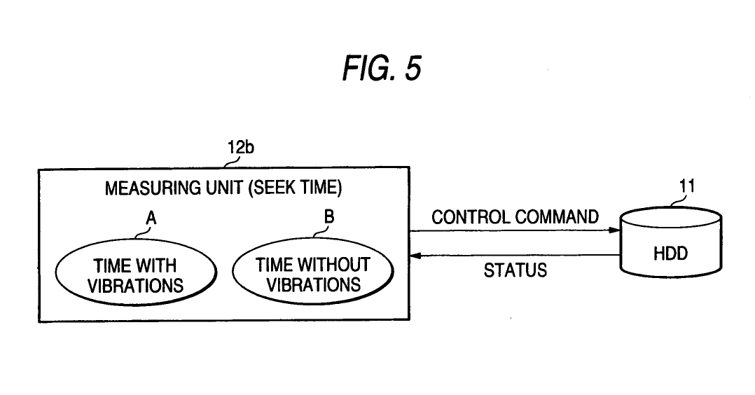

FIG. 5 is an explanatory diagram showing an outline of the measuring unit according to the second embodiment of the invention. As shown in FIG. 5, a measuring unit 12b of this embodiment performs measurement for a functional operation in the HDD 11 by measuring a seek time required for the recording head of the HDD 11 to move between predetermined positions. The measurement can be performed for both of the time for information writing and time for information reading to/from the HDD 11 independently and separately.

The seek time measurement may be performed by a publicly-known technology for both of the time for information writing and time for information reading. For example, a seek time can be measured by predefining two or more positions as the predetermined positions between or among which the recording head can move such as between the home position of the recording head and an innermost circumference track of a disk and between a predetermined track on the inner circumference side of a disk and a predetermined track on the outer circumference side and measuring the time required for moving between or among the predetermined positions.

Furthermore, the measuring unit measures a seek time when vibrations are caused by a vibration source in the multifunction machine 10.

As described above, since the seek time for moving the recording head in the HDD 11 is measured as the measurement for a functional operation in this embodiment, a fault diagnosis can be performed on the HDD 11 accurately, completely like the first embodiment. Furthermore, no special function is required therefor, and the fault diagnosis can be performed easily.

### Third Embodiment

Next, a third embodiment of the invention will be described. Here, only differences between the first embodiment and the third embodiment will be also described, and the description of the rest will be omitted.

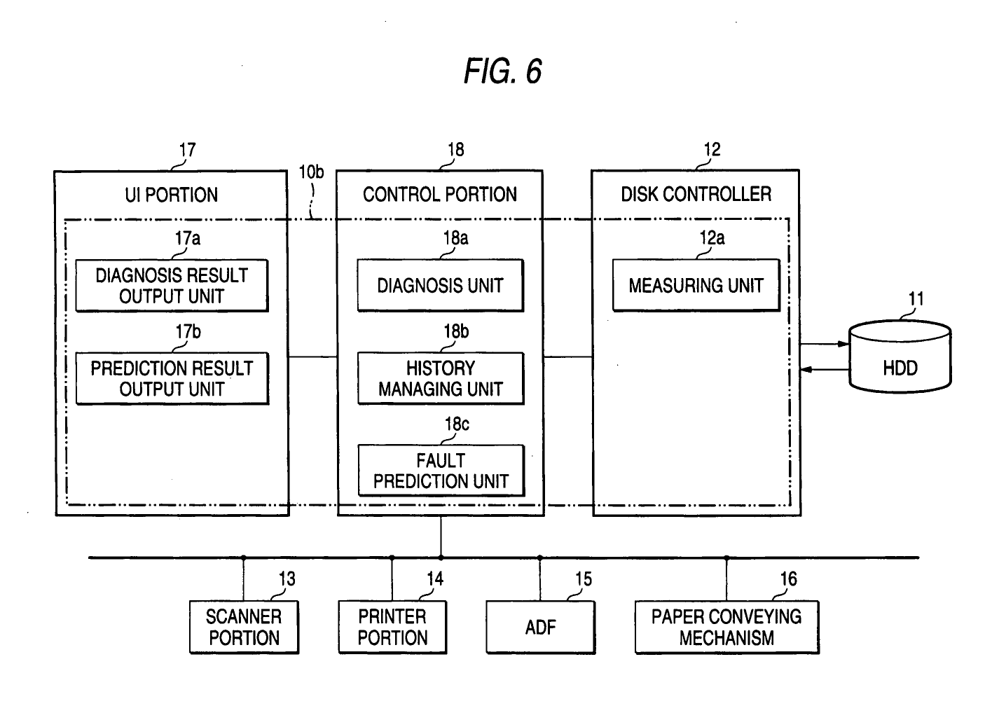

FIG. 6 is a functional block diagram showing a schematic configuration example of a fault diagnosis apparatus according to a third embodiment of the invention and a multifunction machine applying the fault diagnosis apparatus.

As shown in FIG. 6, a fault diagnosis apparatus 10b according to the embodiment is installed and used in a multifunction machine 10. The fault diagnosis apparatus 10b functionally includes a history managing unit 18b, a fault predicting unit 18c and a prediction result output unit 17b in addition to the measuring unit 12a, diagnosis unit 18a and diagnosis result output unit 17a according to the first embodiment. More specifically, the control portion 18 of the multifunction machine 10 functionally includes the history managing unit 18b and fault predicting unit 18c, and the UI portion 17 functionally includes the prediction result output unit 17b.

The history managing unit 18b stores and holds measurement results by the measuring unit 12a in a specific storage area and thus manages a history of the measurement results. The specific storage area only needs to be accessible by the control portion 18 and may be in the HDD 11 or in another memory, not shown.

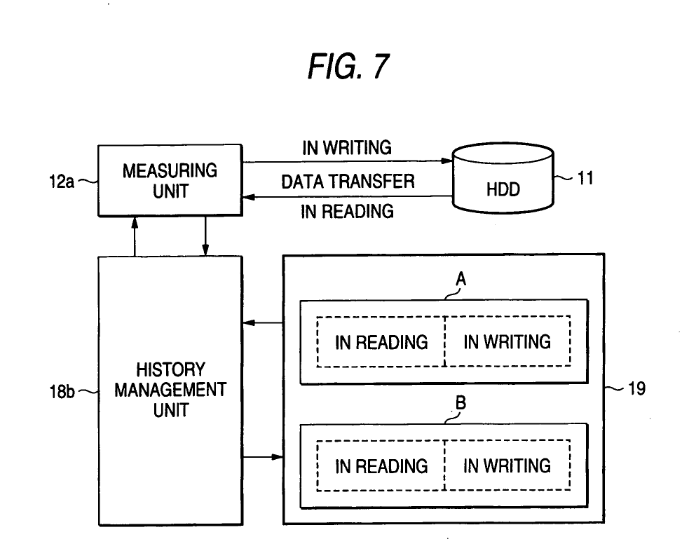

FIG. 7 is an explanatory diagram showing an outline of the storage area for history management. The history managing unit 18b stores and holds measurement results by the measuring unit 12a in the storage area 19 for history management. Here, various measurement results can be stored and held in the storage area 19 separately as shown in FIG. 7. In other words, for example, the measurement result for the time A with vibrations and the measurement result for the time B without vibrations are stored and held separately, and the measurement result for the time for information writing to the HDD 11 and the measurement result for the time for information reading from the HDD 11 are stored and held separately.

The history managing unit 18b manages measurement results by the measuring unit 12a from the initial stage of the operation of the multifunction machine 10 (that is, when the operation is started after shipping to a factory). Therefore, a measurement result by the measuring unit 12a when the multifunction machine 10 is not in use (or at a state close to not being in use) is stored and held in the storage area 19.

In FIG. 6, the fault predicting unit 18c performs fault occurrence prediction based on the history managed by the history managing unit 18b. The fault occurrence prediction is information on a history managed by the history managing unit 18b, that is, on a measurement result stored and held in the storage area 19. More specifically, the fault occurrence prediction may be performed based on elapsed time between measurement timings and the degree of reduction in transfer rate in the timings. The fault occurrence prediction in this case may be performed based on the prediction and determination of the length of the elapsed time required for reducing the transfer rate to the degree that is determined as a fault. In other words, the fault occurrence prediction may be based on the determination on whether the possibility that a fault occurs in near future is high or not or whether the possibility of the fault occurrence is low or not, for example.

The prediction result output unit 17b outputs and displays a result of the fault occurrence prediction by the fault predicting unit 18c to a user of the multifunction machine 10.

Like the other units 12a, 17a and 18a, the units 17b, 18b and 18c may be hardware circuits or may be software functionally operating in a computer. The software configuration in this case may be pre-installed, may be stored in a computer-readable recording medium for provision or may be delivered through a wired or wireless communication unit.

In the fault diagnosis apparatus 10b having this construction, the diagnosis unit 18a performs a fault diagnosis based on transfer rate measurement results by the measuring unit 12a, like the first embodiment. The diagnosis result by the diagnosis unit 18a is output and displayed by the diagnosis result output unit 17a to a user of the multifunction machine 10.

Here, even when the diagnosis by the diagnosis unit 18a does not result in abnormality, that is, when the comparison result between the rate of reduction in transfer rate and a determination reference is enough for being determined as “no problem”, the fault diagnosis apparatus 10b can output and display the result of the fault occurrence prediction to a user of the multifunction machine 10 since the fault diagnosis apparatus lob includes the history managing unit 18b, fault predicting unit 18c and prediction result output unit 17b. In other words, when the diagnosis by the diagnosis unit 18a does not result in abnormality, the fault predicting unit 18c performs a fault occurrence prediction based on the history managed by the history managing unit 18b, and the prediction result output unit 17b outputs and displays the result.

As described above, since the fault predicting unit 18c performs a fault occurrence prediction based on the history managed by the history managing unit 18b and the prediction result output unit 17b outputs and displays the result in this embodiment, the possibility of later abnormality occurrence can be provided with reference to the result of the fault occurrence prediction even when the diagnosis by the diagnosis unit 18a does not result in abnormality. Therefore, an abnormality occurring thereafter can be addressed quickly, which is highly convenient to a user.

In this embodiment, the measuring unit 12a measures transfer rates, for example, as in the first embodiment, but the measuring unit 12a may apparently measure a seek time as in the second embodiment.

### Fourth Embodiment

Next, a fourth embodiment of the invention will be described. Here, only differences between the first embodiment and the fourth embodiment will be also described, and the description of the rest will be omitted.

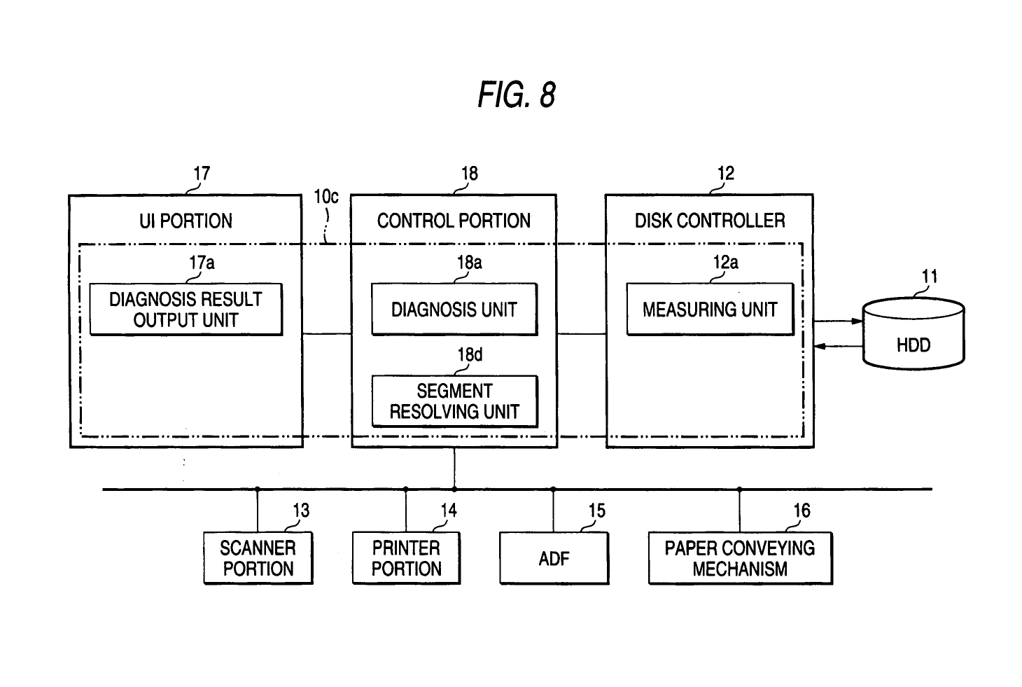

FIG. 8 is a functional block diagram showing a schematic configuration example of a fault diagnosis apparatus according to a fourth embodiment of the invention and a multifunction machine applying the fault diagnosis apparatus.

As shown in FIG. 8, a fault diagnosis apparatus 10b in this embodiment is installed and used in the multifunction machine 10 and further functionally includes a segmentation resolving unit 18d in addition to the measuring unit 12a, diagnosis unit 18a and diagnosis result output unit 17a. More specifically, the control portion 18 of the multifunction machine 10 functionally includes the segmentation resolving unit 18d.

The segmentation resolving unit 18d performs processing for resolving a segmentation of a storage area in the HDD 11. The processing for resolving a segmentation refers to processing of clearing off an unused storage area (garbage) in the HDD 11 and/or a storage area not released by a memory leak and increasing an unsegmented and available storage area and, more specifically, is widely known as so-called garbage collection (defrag). The description of the details of the processing will be omitted herein since the processing may be implemented by using a publicly-known technology.

The segmentation resolving unit 18d may be a hardware circuit like the other units 12a, 17a and 18a or may be software functionally operating in a computer. The software configuration in this case may be pre-installed, may be stored in a computer-readable recording medium for provision or may be delivered through a wired or wireless communication unit.

Next, a processing operation example in the fault diagnosis apparatus 10b having the construction will be described.

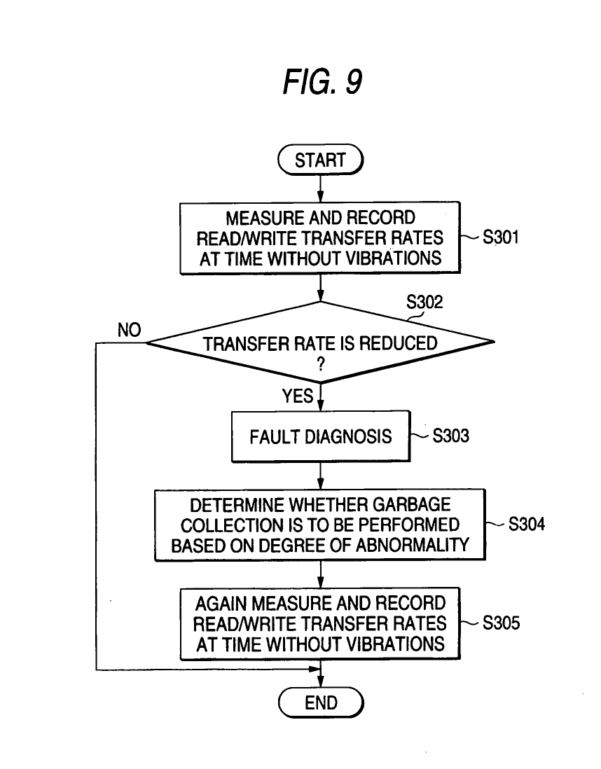

FIG. 9 is a flowchart showing a processing operation example of the fourth embodiment of the invention.

As shown in FIG. 9, in the fault diagnosis apparatus 10b, after the measuring unit 12a measures a transfer rate (S301) the diagnosis unit 18a determines whether the transfer rate is reduced or not based on the measurement result (S302). If the transfer rate is reduced, the diagnosis unit 18a further obtains the rate of reduction and determines the degree of abnormality (S303). The operation up to this point is identical to that of the first embodiment.

In the fault diagnosis apparatus 10b of this embodiment, the diagnosis unit 18a determines whether a garbage collection is to be performed by the segmentation resolving unit 18d or not based on the determined degree of abnormality, in addition to the determination of the degree of abnormality from the rate of reduction of the transfer rate (S304). The correspondence relationship between the degree of abnormality and the necessity of the garbage collection is predefined here. When the diagnosis unit 18a determines to perform a garbage collection, the segmentation resolving unit 18d in accordance with the determination performs a garbage collection on the HDD 11 and resolves the segmentation in the storage area.

Then, the measuring unit 12a measures a transfer rate again (S305) for the HDD 11 that the segmentation is resolved by the garbage collection, and the diagnosis unit 18a performs a fault diagnosis based on the measurement result. Thus, the possibility of improving a determination result on the degree of abnormality may be higher than that before the garbage collection after the segmentation of the storage area in the HDD 11 is resolved. This is because the transfer rates tends to be lower as the segmentation of the storage area advances even when no fault occurs in the HDD 11, for example.

As described above, since the segmentation resolving unit 18d performs a garbage collection on the HDD 11 and resolves a segmentation of the storage area in this embodiment, the segmentation can prevent the misdetermination of a reduction in a transfer rate as a fault. As a result, the accuracy of the fault diagnosis can be enhanced.

The determination result by the diagnosis unit 18a may automatically trigger the garbage collection by the segmentation resolving unit 18d as described above or an input operation by a user on the UI portion 17 may trigger the garbage collection by the segmentation resolving unit 18d.

Also in this embodiment, like the first embodiment, the measuring unit 12a measures a transfer rate, for example, but the measuring unit 12a may apparently measure a seek time as in the second embodiment.

Furthermore, this embodiment may be implemented in combination with the third embodiment.

While the first to fourth embodiments are specific examples of the invention, the invention is not limited to the details and may be changed and modified without departing from the spirit and scope thereof. For example, the invention can be completely similarly applicable to any information equipment having a disk drive typically such as the HDD 11, which has a vibration source within the equipment itself such as the multifunction machine 10 or which is used in an environment subject to vibrations from an external vibration source such as a car navigation system.

As described above, some embodiments of the invention are outlined below.

According to an embodiment of the invention, a fault diagnosis apparatus for use in information equipment having a disk drive that stores information and having a vibration source that causes vibrations or being subject to vibrations from an external vibration source includes a measuring unit that performs a measurement for a functional operation in the disk drive under a condition that the vibrations are occurred by the vibration source, and a diagnosis unit that performs a fault diagnosis based on a measurement result by the measuring unit.

According to another embodiment of the invention, a recording medium recording a fault diagnosis program for use in information equipment having a disk drive that stores information and having a vibration source that causes vibrations or being subject to vibrations from an external vibration source causes the information equipment to function as a measuring unit that performs a measurement for a functional operation in the disk drive under a condition that the vibrations are occured by the vibration source, and a diagnosis unit that performs a fault diagnosis based on a measurement result by the measuring unit.

According to another embodiment of the invention, a fault diagnosis method for use in information equipment having a disk drive that stores information and having a vibration source that causes vibrations or being subject to vibrations from an external vibration source includes a measuring step of performing a measurement for a functional operation in the disk drive under a condition that the vibrations are occurred by the vibration source, and a diagnosis step of performing a fault diagnosis based on a measurement result by the measuring step.

In the fault diagnosis apparatus and the recording medium recording a fault diagnosis program having the constructions and the fault diagnosis method having the steps, a measurement for a functional operation in the disk drive is performed at least at the time with vibrations by a vibration source. The expression, “at least”, refers to that the measurement only needs to be performed at the time with vibrations by the vibration source and the measurement may be performed both at the time with vibrations by a vibration source and the time without vibrations. The expression, “measurement for a functional operation”, refers to a measurement to be performed for detecting an operation state of the disk drive and supplying the result to the fault diagnosis and a measurement which can be performed in accordance with an operation command to a disk drive without requiring any special function such as signal processing. More specifically, the expression, “measurement for a functional operation”, may refer to a measurement of a transfer rate during information transfer in a disk drive or a measurement of a seek time when the head of the disk drive moves between or among predetermined positions.

After a measurement for a functional operation is performed, a fault diagnosis is performed based on the measurement result. The fault diagnosis in this case may be performed by comparing the measurement result with a predetermined reference value or with a measurement result obtained in the past or by comparing measurement results at both of the time with vibrations and the time without vibrations if any, for example.

As described above, since, in the fault diagnosis apparatus, recording medium recording a fault diagnosis program and fault diagnosis method according to the embodiments of the invention, a measurement for a functional operation in a disk drive is performed under a condition that the vibrations are occurred by a vibration source, an accurate fault diagnosis can be performed on the disk drive even when vibrations caused by a vibrations source have an influence on information equipment having the disk drive. Furthermore, since the fault diagnosis is performed based on the measurement result for a functional operation in the disk drive, a measurement result can be obtained in accordance with an operation command to the disk drive. Since no special function such as signal processing is required, the fault diagnosis can be performed easily.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-365361 filed on Dec. 17, 2004 including specification, claims, drawings and abstract is incorporated herein by reference in its entirety.

What is claimed is:

1. A fault diagnosis apparatus installed and used in information equipment having a disk drive and having a vibration source that causes vibrations or being subject to vibrations from an external vibration source, the apparatus comprising:
a measuring unit that performs a measurement for a functional operation in the disk drive under a condition that the vibrations are occurred; and
a diagnosis unit that performs a fault diagnosis based on a measurement result by the measuring unit.

2. The fault diagnosis apparatus according to claim 1, wherein the measuring unit performs the measurement for a functional operation both under the condition that the vibrations are occurred and a condition that the vibrations are not occurred; and
the diagnosis unit performs a fault diagnosis based on both of the measurement result under the condition with the vibrations and the condition without the vibrations.

3. The fault diagnosis apparatus according to claim 1, wherein the measuring unit measures a transfer rate for information transfer in the disk drive as the measurement for a functional operation.

4. The fault diagnosis apparatus according to claim 3, wherein the measuring unit measures the transfer rate for each of information writing to the disk drive and information reading from the disk drive.

5. The fault diagnosis apparatus according to claim 1, wherein the measuring unit measures a seek time when a head of the disk drive moves between or among predetermined positions as the measurement for a functional operation.

6. The fault diagnosis apparatus according to claim 1, wherein powering on the information equipment triggers the measuring unit to perform the measurement for a functional operation.

7. The fault diagnosis apparatus according to claim 1, wherein the measuring unit performs the measurement for a functional operation periodically at predetermined dates and times.

8. The fault diagnosis apparatus according to claim 1, wherein, when the information equipment has a plurality of operation modes and a plurality of vibration sources, and the vibration source that causes vibrations depends on each operation mode, the measuring unit performs the measurement for a functional operation in a specific operation mode.

9. The fault diagnosis apparatus according to claim 8, wherein the specific operation mode is an operation mode to be implemented in response to a manipulation on an operating portion included in the information equipment.

10. The fault diagnosis apparatus according to claim 8, wherein the specific operation mode is an operation mode to be implemented independent of a manipulation on an operating portion included in the information equipment.

11. The fault diagnosis apparatus according to claim 1, further comprising;
a diagnosis result output unit that outputs and displays a result of a fault diagnosis by the diagnosis unit.

12. The fault diagnosis apparatus according to claim 1, further comprising:
a history managing unit that manages a history of measurement results by the measuring unit.

13. The fault diagnosis apparatus according to claim 12, further comprising:
a fault predicting unit that performs a fault occurrence prediction based on a history managed by the history managing unit.

14. The fault diagnosis apparatus according to claim 13, further comprising:
a prediction result output unit that outputs and displays a result of the fault occurrence prediction by the fault predicting unit.

15. The fault diagnosis apparatus according to claim 1, further comprising:
a segmentation resolving unit that performs processing for resolving a segmentation of a storage area in the disk drive.

16. A recording medium recording a fault diagnosis program for use in information equipment having a disk drive and having a vibration source that causes vibrations or being subject to vibrations from an external vibration source, the recording medium comprising:
measuring for a functional operation in the disk drive under a condition that the vibrations are occurred; and
performing a fault diagnosis based on a measurement result by the measuring of the functional operation.

17. A fault diagnosis method for using in information equipment having a disk drive and having a vibration source that causes vibrations or being subject to vibrations from an external vibration source, the method comprising:
measuring a functional operation in the disk drive under a condition that the vibrations are occurred; and
performing a fault diagnosis based on a measurement result by the measuring of the functional operation.
